(19) United States
(12) Patent Application Publication
(10) Pub. No.: US 2015/0018102 A1
(43) Pub. Date: Jan. 15, 2015

(54) GAME APPARATUS

(71) Applicant: CAPCOM CO., LTD., Osaka-sh (JP)

(72) Inventors: Koshi Nakanishi, Amagasaki-shi (JP); Hidehiro Goda, Neyagawa-shi (JP)

(21) Appl. No.: 14/371,623

(22) PCT Filed: Jan. 8, 2013
(86) PCT No.: PCT/JP2013/000015

§ 371 Date: Jul. 10, 2014

(30) Foreign Application Priority Data
Jan. 10, 2012 (JP) 2012-002201

(51) Int. Cl. A63F 13/335; A63F 13/31

(52) U.S. Cl. CPC A63F 13/335; A63F 13/31
USPC 463/40

(57) ABSTRACT

A game apparatus has a storage unit in which a communication record area that stores user data of the game apparatus and a communication record between the game apparatus and a partner game apparatus is established, a game unit for performing a game in response to user's operation, an automatic communication unit for receiving automatically the user data of the partner game apparatus from the partner game apparatus via the direct communication, in a case in which a distance between the game apparatus and the partner game apparatus is within a distance which is capable of conducting direct communication, and an internet play unit for receiving automatically the user data of the partner game apparatus from the partner game apparatus via the internet communication, instead of the direct communication, when a distance between the game apparatus and the partner game apparatus is far from the distance which is capable of conducting the direct communication.

### TECHNICAL FIELD

The present invention relates to a game device which performs alternative automatic short-range communication via the internet; hereinafter, automatic short-range communication is referred to as “ASC”.

### BACKGROUND ART

As shown on web site “Nintendo 3DS (a registered trade mark), a strong point (the way of enjoying, which is extended by data communications)” [symbol] URL: http://www.nintendo.co.jp/3ds/hardware/features/features02. html [symbol] , a game device having ASC has been widely used. The ASC is a function that each of the portable game devices communicates with each other without its user's operation, when a plurality of portable game devices are close to each other. In the ASC, user data of the game devices are mutually exchanged. In the game performed in the game device, a special favor such as a special mission, a special item or the like is given to the user (player) each time the game device performs the ASC or when the game device performs the ASC with a certain number of game devices or more. The special favor such as the special mission, the special item or the like isn't given in normal acquisition of a point or normal completion of a mission, which is, for example, “Street Pass Communication” of “Pocket Monster Black and White (a registered trademark)” is well-known [symbol] URL: http://www.pokemon.co.jp/series/bw/#/connection/connection07.html [symbol] .

### SUMMARY OF INVENTION

### Technical Problem

To acquire such special favors, it is necessary to perform the ASC by approaching a distance capable of communicating with another game device mutually. Users who can bring their game devices to the place where there are many people who bring their game devices, for example, to an inner city, can perform a lot of the ASC, however, users who cannot bring their game devices, for example, who live in a countryside and the like, can hardly perform the ASC. It is more difficult for the users who live far from other users such as overseas players to perform the ASC.

The present invention is aimed at providing a game device that can perform the ASC in an alternative way, even if there are few opportunities of approaching another game device or the game device is far from another game device.

### Solution to Problem

A game apparatus of the present invention has a storage unit, a game processing unit, an ASC unit, and an internet play processing unit and communicates with a partner game apparatus via wireless direct communication and internet communication. A communication record area that stores user data of the game apparatus and communication record with the partner game apparatus is established in the storage unit. The game processing unit performs the game in response to user's operation. The ASC unit automatically receives the user data of the partner game apparatus from the partner game apparatus via the direct communication when the game apparatus and the partner game apparatus are within a distance which is capable of conducting the direct communication. The Internet play processing unit automatically receives the user data of the partner game apparatus from the partner game apparatus via the internet communication, instead of the direct communication, when the distance between the game apparatus and the partner game apparatus is too far to conduct direct communication.

In the present invention, the user data which is obtained in the ASC unit and the alternative ASC unit (a process, means) may be saved in an ASC list and an alternative ASC list respectively.

In the present invention, the game processing unit may perform special processing that isn't performed in a normal time when the number of the user data stored in the communication record area becomes a predetermined value or more. Further, the game unit adds the number of the user data stored in the ASC list and the number of the user data stored in the alternative ASC list with each different weighting and may perform the special processing when this additional value becomes a predetermined value or more.

### Advantageous Effects of Invention

According to the present invention, it is possible to increase the number of users who can perform alternative ASC by performing the alternative ASC via internet communication, even if each of the users has few opportunities for performing the ASC by approaching each of the game devices.

### BRIEF DESCRIPTION OF DRAWINGS

FIG. 1 is a block diagram of a game apparatus in which a game program of the present invention is loaded.

FIG. 2 is a functional block diagram of the game apparatus which is configured by cooperation between the game device and a game program.

FIG. 3 is a memory configuration diagram of the game device.

FIG. 4 is a diagram illustrating an ASC and an alternative ASC.

FIG. 5 is a flowchart illustrating an action of the game apparatus.

FIG. 6 is a flowchart illustrating action of the game apparatus.

### DESCRIPTION OF EMBODIMENTS

Referring to the figures, a game program and a game apparatus (a game system) configured by the game program and a game device (a hardware) that are embodiments of the present invention, will be described. Also, in the description below, “store” and “save” are used as general science and technology terms known conventionally.

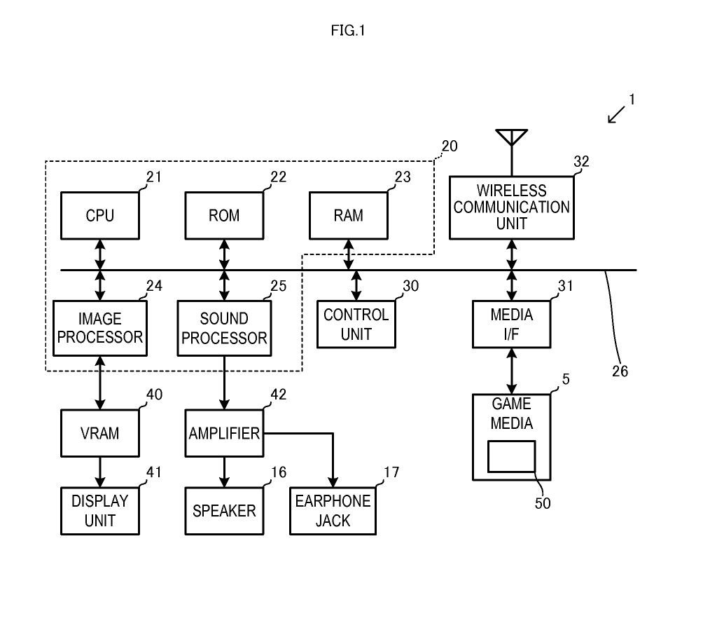

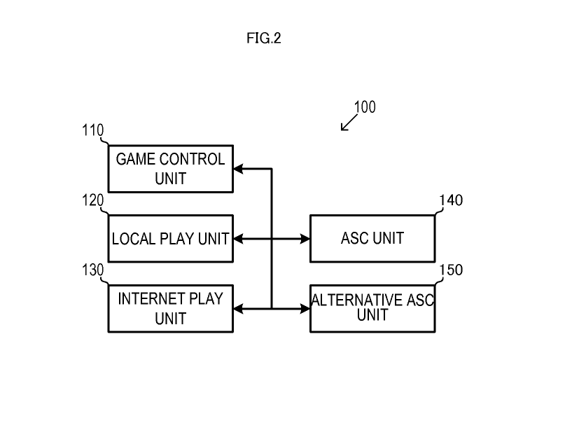

FIG. 1 is a block diagram of an electronic circuit of a game device 1. Also, FIG. 2 is a functional block diagram of the game apparatus 100 configured by cooperation between the game device 1 and the game program 50. The game performed by the game program proceeds by making an object move, fight with enemies, and run to finish in response to user's (player's) operation.

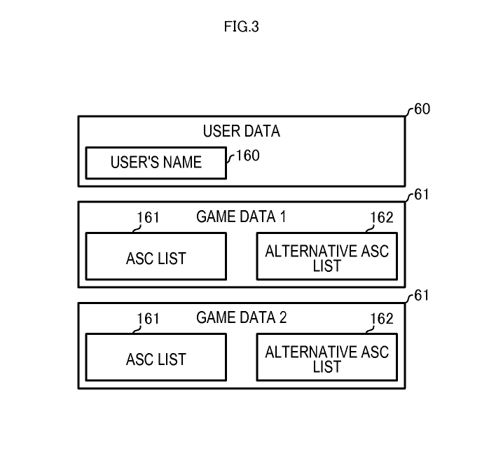

An embodiment of performance of the game has a single play and a multiple play. The single play is a mode that the game device 1 performs the game alone. The multiple play is a mode that plural game devices 1 perform the same synchronized game by communicating with each other. Also, the multiple play includes a local play and an internet play and it is determined by a communication system which to use. The local play is a mode that the multiple play is performed by communicating directly, for example, via BLUETOOTH (a registered trade mark) without the internet. The internet play is a mode that the plural game devices 1 performed the multiple play by communicating via the internet 2 (See, FIG. 3). Also, the multiple play has a match play that each user of game devices 1 plays a match with other users and a co-op play that each user of game devices 1 plays the game together as friends.

In the present embodiment, an explanation of specific proceed of the game won't be mentioned and the processing of the ASC will be explained.

The ASC is a function that each of the users' data is exchanged automatically without users' operation when two game apparatuses 100, whose local communication function are turned on are close to each other, for example, which is called “Street Pass Communication” (a registered trade mark). Exchanged user data is saved in the ROM (flash memory) 22 of the game apparatus 100 (game device 1). In the ROM 22, an automatic communication list 161 (See FIG. 3) is provided as an area to save the exchanged user data. According to the number of the user data (the number of the execution of the ASC) acquired by the ASC, a special favor which the user cannot get at any other points is provided to the user of the game apparatus 100. The special favor is, for example, a new mission, item or the like of the game, or an increase in items which a user has already had in the game.

Also, the game apparatus 100 exchanges the user data with the partner game apparatus and saves the exchanged user data into the ROM 22 when the game apparatus 100 performs the internet play. Exchange of the user data by the internet play is called the alternative ASC (or “pseudo Street Pass Communication”). An area provided in the ROM 22 to save the exchanged user data by the alternative ASC is called an alternative ASC list 162. To give the special favor mentioned above, the number of memory of the alternative ASC (the number of performance of the alternative ASC) is added to the number of the ASC when whether the number of the ASC exceeds a predetermined number is determined. According to this, a user who lacks an opportunity of the ASC can get the special favor easily by playing the internet play.

FIG. 1 is a block diagram of an electronic circuit of the game device 1. The game device 1 has a control unit 20, an operation unit 30, a media interface 31 and a wireless LAN communication unit 32 on the bus 26. The control unit 20 includes a CPU 21, a ROM (flush memory) 22, a RAM 23, an image processor 24 and a sound processor 25. The image processor 24 is connected to a video RAM (VRAM) 40, and the video RAM is connected to a display unit 41. The display unit 41 includes a liquid crystal display and displays a game screen. The sound processor 25 is connected to an amplifier 42 including a D/A converter, and the amplifier 42 is connected to a speaker and an earphone jack.

The operation unit 30 includes a touch panel, buttons, a direction key and a touch pad formed on the display. Each function of the operation unit 30 accepts the user's operation and generates an operation signal in response to the content of operation thereof. The operation signal is read by the CPU 21.

The media interface 31 includes a media slot into which a game media 5 is inserted. In the game media 5 inserted into the media slot, the game program 50 is stored. The game program 50 includes game data necessary for the progress of the game. An exclusive semiconductor memory is used as the game media 5. The game media 5, however, is not limited to the exclusive semiconductor and may be an all-purpose semiconductor, an optical disk or the like.

In the RAM 23, a road area for storing the game program 50 read out of the game media 5 and a work area used when the CPU 20 executes the game program 50 are set. In the ROM 22, a basic program which the game device 1 uses for reading the game program 50 from the game media 5 and executing a game and a program for ASC mentioned below are stored. Also, the ROM 22 is a flash memory, and an area for storing personal data and game data shown in FIG. 3 as nonvolatile data is set in the ROM 22 in addition to the program 50.

An image processor 24 has a GPU (Graphics Processing Unit), and generates a game image. The image processor 24 generates a game space according to the instruction from the CPU 21 and draws an image obtained by photographing the game space by a virtual camera as the game image on the VRAM 40.

The sound processor 25 has a DSP (Digital Signal Processor) and generates game sound. The sound processor 25 reproduces sound data, that an object produces sound according to activities of the objects. The amplifier 42 amplifies the sound signal and outputs it to the sound speaker 16 and the earphone jack 17.

A wireless communication unit 32 has a digital communication circuit for 2.4 GHz band and performs the internet communication via wireless access point and communicates with another game device directly. The communication executed with the game device directly is called a local communication. The wireless communication unit 32 communicates by IEEE802.11g standard (what is called “Wi-Fi”) when it executes the internet communication. On the other hand, the wireless communication circuit unit 32 communicates by an ad hoc mode of IEEE802.11b or its own standard when it communicates locally. The local communication is used for the ASC and the local play. Furthermore, the internet communication is used for the internet play, download of a program or the like.

Then, referring to the block diagram shown in FIG. 2, the game device (game system) 100 performed by the game program 50 in the game media 5 being read into the game device 1 (a hardware) will be explained. The game apparatus 100 performed by the game program 50 being read into the game device 1 includes a game unit 110, a local play unit 120, an internet play unit 130, an ASC unit 140, and an alternative ASC unit 150.

The game unit 110 generates a virtual game space by using the image processor 24 and performs the processing of the game itself making the character act in the virtual game space. The local play unit 120 cooperates with the game unit 110 and processes the local play which is the multiple play with local communication. The internet play unit 130 cooperates with the game unit 110 and processes the internet play which is the multiple play via the internet 2. The ASC unit 140 processes the ASC, which is exchange of the user data with the local communication. The alternative ASC unit 150 processes the alternative ASC which is exchange of game data with the internet play.

In the configuration of the game apparatus 100, the game unit 110, the local play unit 120, the internet play unit 130 and the alternative ASC unit 150 are constructed by executing the game program 50 stored in the game media 5. In the configuration of the game apparatus 100, the ASC processing unit 140 is constructed by executing the game program stored in the ROM 22 in advance for the ASC. The game media 5 is connected to the media interface 31 and the game program 50 is executed. Then the game data storing area 61 in FIG. 3 is generated. Hereafter, even when the game media 5 is not connected to the media interface 31 (when the game media 5 is unplugged from the media slot), the ASC is performed. That is, when the game program 50 is executed firstly, the ASC unit 140 is built. Hereafter, even when the game program 50 is not executed, the ASC unit 140 is performed by a program for the ASC stored in the ROM 22.

In the game device 1 of the present embodiment, the program for constructing the ASC unit 140 is stored in the ROM 22 in advance, however, this program may be also stored in the game media 5 as a part of the game program 50 and be read into the game device 1 when the game program 50 is executed.

In addition, the automatic communication unit 140 may not be always turned on, for example, the user may be able to turn it on/off manually. Also, when the game is not performed, the ASC unit 140 may be operated in an electric power saving mode such as a sleep mode.

FIG. 3 is a diagram showing the storage area provided in the ROM 22 which is a flash memory. In order to construct the game apparatus 100 in the game device 1, a personal storage area 60 for storing data regarding the user in the game device and a game data storage area 61 for storing data regarding the game performed in the game device 1 are provided in the ROM 22. In the personal data storage area 60, a user's name storage area 160 for storing a user's name and an area for storing a data of birth and the like are provided. Also, the ASC list 161 and the alternative ASC list 162 mentioned above are provided in the game data storage area 61. The game data storage area 61 is provided in each performed game and generated when the game program 50 is executed for the first time. Only one personal data storage area 60 is provided in FIG. 3, but several personal data storage areas can be provided.

The game apparatus 100 may exchange the user's individual data stored in the personal data storage area 60 as the user data or may exchange information regarding the game such as the information of the user's individual data and game progress.

In FIG. 3, the ASC list 161 and the alternative ASC list 162 are provided separately, however, one automatic communication list is provided, and user data which is acquired with the ASC and the alternative ASC may be stored in the same list.

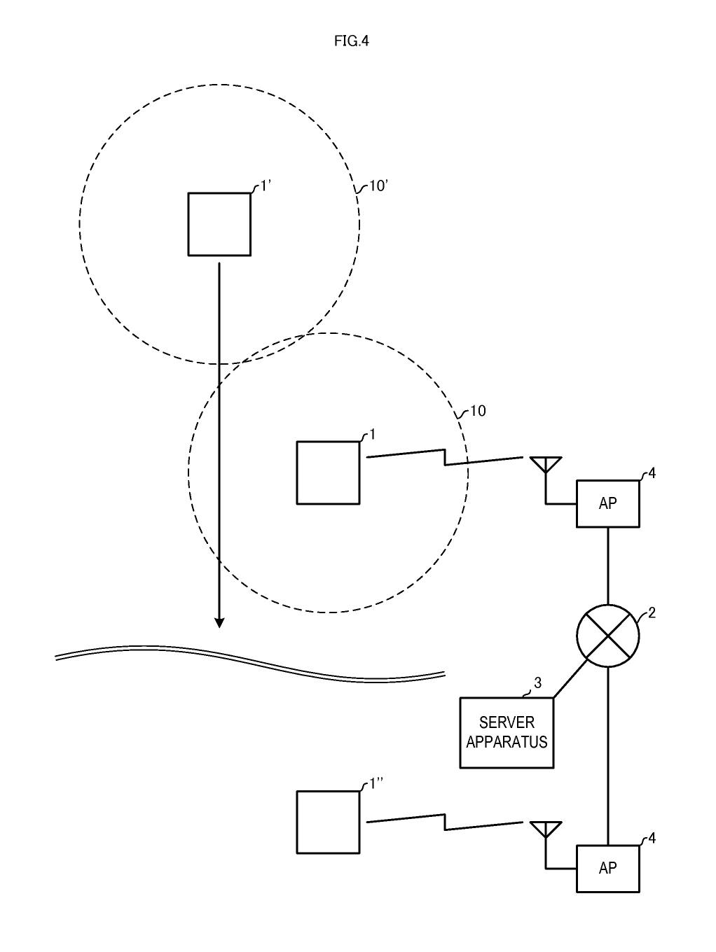

Referring to FIG. 4, the ASC and alternative ASC will be explained. The game device 1 has a local communication area 10 which is within a distance capable of local communication with the wireless communication unit 32. In addition, a game device 1′ which is different from the game device 1 has a local communication area 10′ as well. If either or both of the game device 1 and the game device 1′ moves, that is, either or both of the user carrying the game device 1 and the user carrying the game apparatus 1′ moves and goes into the local communication area 10 or 10′, the ASC for exchanging each other's game data with the local communication will be performed.

In addition, the game device 1 is connected to the internet 2 via a wireless access point (AP) 4. The internet 2 is connected to the server apparatus 3. Information of a game device 1″ which is different from the game device 1 or 1′ and expects an internet play is registered in the server apparatus 3. The game apparatus 1″ as well is connected to the internet 2 via the wireless access point 4. The game device 1 is connected to the game device 1″ via the internet 2 and performs the internet play synchronously based on the information of the game device 1″ registered in the server apparatus 3. The alternative ASC in which the user data are exchanged each other is performed at this time. As the game device 1″ is connected to the game device 1 via the internet 2, a physical distance between the game device 1 and the game device 1″ does not matter.

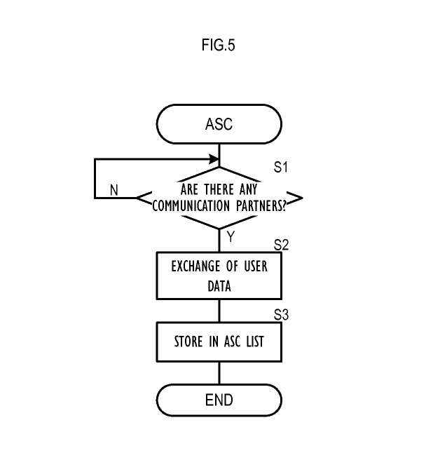

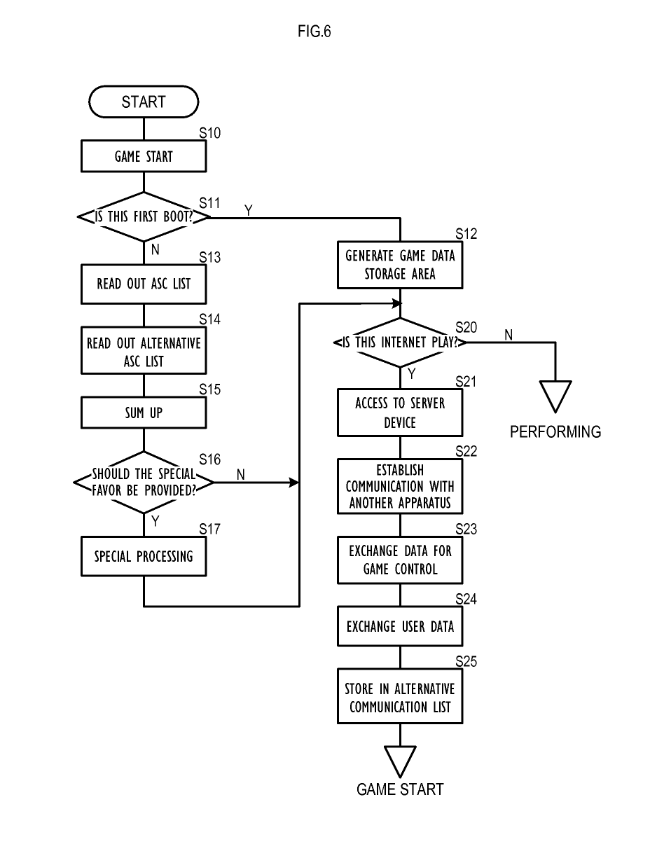

Referring to FIG. 5 and FIG. 6, the ASC and the alternative ASC will be explained.

FIG. 5 is a flowchart showing the processing of the ASC. With or without the execution of the game program 50, this action is performed by the program for the ASC stored in the ROM 22. The game device 1 (the control unit 20 of the game device 1) always monitors whether the game device 1′ in which a function of the ASC is validated goes into the local communication area 10 or not. If the game device 1′ in which the function of the ASC is validated goes into the local communication area 10 (S1: YES), the game device 1 exchanges the user data such as the user's name by communicating with the game device 1′ automatically (S2). Then, the user data is saved with communication date in the ASC list 161 (S3).

FIG. 6 is a flowchart showing an action of the game device 1 executing the game program 50. When the game program 50 is started by the operation by the user, the game device 1 determines whether this game is started for the first time or not. If this is the first time of starting (S11: YES), the game device 1 moves to a game start action written in S20 after generating the game data storage area 61 for the game on the ROM 22.

When this is not the first time of starting (S11: NO), the game device 1 contacts the game data storage area 61 of the game, reads out the record of the ASC from the ASC list 161 (S13), reads out the record of the alternative ASC from the alternative ASC list 162 (S14), and sums up (S15).

The sum is a calculation, for example, which totals the number of people excluding the overlap between the user data stored in the ASC list 161 and the user data stored in the alternative ASC list 162. In addition, data whose record date is old may be deleted, weighting of the number of the alternative ASC and the number of the ASC may be totaled differently in this sum.

Then, the game device 1 determines whether the number of people of the sum results reaches the required number of people for providing special a favor or not. If the number of people doesn't reach the required number for providing the special favor (S16: NO), the game device 1 moves a processing to S20. If the number of people reaches the required number (S16: YES), the game device 1 moves to S20 after performing processing for providing the special favor. The special favor is for example occurrence of a new mission in the game or acquisition of a new item in the game, and there is no limit on methods for selection or determination regarding what kind of a special favor is provided and which of the special favor is provided to the player.

The game device 1 determines whether or not this game is an internet play or not in the S20. That is, the game device 1 determines whether the user of the game device 1 selects a multiple play via internet or other play manners (a single play or a local play) when the game is started.

If the internet play is selected (S20: YES), the game device 1 connects to the server 3 via the internet 2 using the wireless communication unit 32, finds a cooperative player or a competitor player, and sets up communication with the game device 1″ of the player. Then, the game device 1 exchanges the data for game control so as to perform the internet play (S23) and exchanges the user data for the ASC. The user data of the game device 1″ acquired by this exchange is saved in the alternative ASC list 162 (S25). After that, the game is started. If either the single play or local play is selected (S20: NO), a processing corresponding to the play manner is performed.

In the ASC and the alternative ASC, it has been written that each of the user data is exchanged mutually, however, it may only acquire the user data from the game device 1′ or 1″.

In addition, any contents of data can be exchanged. For example, the data regarding the game device, game data in a specific game, and data (e.g. profile) registered by the user himself/herself may be acceptable.

When the game data in the middle of the specific game is received in the ASC, the specific game may have been not performed yet in the game device 1. At the time when the game date sent from the game device 1′ is stored as it is, the specific game program 50 is executed for the first time, and the ASC list 161 is generated, the game data may be saved in the ASC list 161.

Also, a manner of communication performing the alternative ASC is not limited to the internet communication via Wi-Fi and any manner of communication such as the internet communication via cable wired LAN or peer to peer communication via cable wired LAN or Bluetooth (a registered trade mark) may be acceptable.

In a case in which a function of the ASC can be turned on/off and the ASC is turned on, the alternative ASC can be also unable to function. Also, the alternative ASC can be turned on/off independently, in spite of whether the ASC function is turned on/off.

In this embodiment, the game device 1 which is used for games only is explained as an example, however, the present invention is able to be applied to a device which is not used for games, for example, a cell phone such as a smart phone, a tablet device and a personal computer.

### DESCRIPTION OF SYMBOLS

1 game device
5 game media
20 control unit
21 CPU
22 ROM (flash memory)
50 game program
60 personal data storage area
61 game data storage area
161 ASC list
162 alternative ASC list

1. A game apparatus communicating with a partner game apparatus via wireless direct communication and internet communication comprising:
a storage unit in which a communication record area that stores user data of the game apparatus and communication record with the partner game apparatus is established;
a game processing unit for performing a game in response to user's operation;
an ASC unit for receiving automatically the user data of the partner game apparatus from the partner game apparatus via the direct communication when the game apparatus and the partner game apparatus are within a distance which is capable of conducting the direct communication; and
an internet play processing unit for receiving automatically the user data of the partner game apparatus from the partner game apparatus via the internet communication, instead of the direct communication, when the distance between the game apparatus and the partner game apparatus is too far to conduct direct communication.

2. The game apparatus according to claim 1,
wherein an ASC list and an alternative ASC list are set in the storage unit as the communication record area;
wherein the ASC unit saves the user data of the partner game apparatus in the ASC list;
wherein the internet play processing unit further saves the user data of the partner game apparatus in the alternative ASC list.

3. The game apparatus according to claim 1,
wherein the game processing unit performs special processing that isn't performed in a normal time when the number of the user data stored in the communication record area becomes a predetermined value or more.

4. The game apparatus according to claim 2,
wherein the game processing unit adds the number of the user data stored in the ASC list and the number of the user data stored in the alternative ASC list with each different weighting and performs the special processing when an additional value becomes a predetermined value or more.
